(19) United States
(12) Patent Application Publication
(10) Pub. No.: US 2025/0251769 A1
(43) Pub. Date: Aug. 7, 2025

(54) SYSTEM PEAK CURRENT MANAGEMENT FOR MOBILE DEVICES

(71) Applicant: QUALCOMM Incorporated, San Diego, CA (US)

(72) Inventors: Dipti Ranjan PAL, Irvine, CA (US); Aseem PANDEY, San Diego, CA (US); Manish GOEL, San Diego, CA (US); Shih-Hsin Jason HU, San Diego, CA (US)

(21) Appl. No.: 18/936,515

(22) Filed: Nov. 4, 2024

Related U.S. Application Data
(60) Provisional application No. 63/550,374, filed on Feb. 6, 2024.

(51) Int. Cl. G06F 1/3206; G06F 1/3234

(52) U.S. Cl. CPC G06F 1/3206; G06F 1/3234

(57) ABSTRACT

Aspects of the disclosure are directed to peak current mitigation. In accordance with one aspect, the disclosure includes managing a plurality of peak current events based on a plurality of peak current detection messages to generate a management plan; and mitigating the plurality of peak current events using a plurality of mitigation actions from the management plan. And, the disclosure includes a processing engine configured to perform general purpose processing; and a power management integrated circuit (PMIC) coupled to the processing engine, the PMIC configured to manage a plurality of peak current events associated with the processing engine based on a plurality of peak current detection messages to generate a management plan, and configured to mitigate the plurality of peak current events using a plurality of mitigation actions from the management plan.

### CLAIM OF PRIORITY UNDER 35 U.S.C. § 119

The present Application for Patent claims priority to Provisional Application No. 63/550,374 entitled “System Peak Current Management For Small Mobile Devices” filed Feb. 6, 2024, and assigned to the assignee hereof and hereby expressly incorporated by reference herein.

### TECHNICAL FIELD

This disclosure relates generally to the field of computer processor architecture, and, in particular, to management of peak current for a plurality of processing engines.

### BACKGROUND

An information processing system, for example, a computing platform, strives for a balance between processing throughput and dc current management. In the case of a mobile device, such as an extended reality (XR) device, a small battery is used as dc power supply which constrains operational utility of the device. An improvement in dc current management for a mobile device may be needed, particularly when a plurality of processing engines are embedded in the device. Thus, there may be a strive for peak current mitigation.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides peak current mitigation. Accordingly, an apparatus including: a processing engine configured to perform general purpose processing; and a power management integrated circuit (PMIC) coupled to the processing engine, the PMIC configured to manage a plurality of peak current events associated with the processing engine based on a plurality of peak current detection messages to generate a management plan, and configured to mitigate the plurality of peak current events using a plurality of mitigation actions from the management plan.

In one example, the PMIC is further configured to send the plurality of peak current detection messages based on a detection of the plurality of peak current events. In one example, the processing engine is further configured to send the plurality of peak current detection messages based on a detection of the plurality of peak current events. In one example, the apparatus further includes a digital power meter (DPM) residing within the processing engine, the digital power meter configured to measure a current load demand based on a voltage, a clock frequency, a temperature and a workload of the processing engine.

In one example, the apparatus further includes a digital power meter (DPM) residing within the processing engine, the digital power meter configured to measure a current load demand based on a voltage, a clock frequency, a temperature and a workload of the processing engine. In one example, the apparatus further includes a current sensor residing within the processing engine, the current sensor configured to compare a monitored current load of the processing engine with a current threshold. In one example, the apparatus further includes a current sensor residing within the processing engine, the current sensor configured to compare a monitored current load of the processing engine with a current threshold.

Another aspect of the disclosure provides a method including: managing a plurality of peak current events based on a plurality of peak current detection messages to generate a management plan; and mitigating the plurality of peak current events using a plurality of mitigation actions from the management plan.

In one example, the method further includes sending a plurality of trigger signals based on the plurality of mitigation actions. In one example, the method further includes triggering the plurality of mitigation actions based on one or more overcurrent conditions conveyed on the plurality of peak current detection messages.

In one example, the management plan includes a plurality of configuration tables used to determine the plurality of mitigation actions. In one example, the plurality of configuration tables includes a mitigation prioritization table or a mitigation duration table. In one example, the plurality of mitigation actions includes an adjustment of a dynamic clock voltage scaling (DCVS) setpoint, a clock frequency reduction, an architectural instruction throttle or a processing engine toggle.

In one example, the method further includes sending the plurality of peak current detection messages based on a detection of the plurality of peak current events. In one example, the method further includes detecting the plurality of peak current events while executing one or more processing tasks using a plurality of processing engines to generate the detection of the plurality of peak current events.

Another aspect of the disclosure provides an apparatus for peak current mitigation including: means for managing a plurality of peak current events based on a plurality of peak current detection messages to generate a management plan; and means for mitigating the plurality of peak current events using a plurality of mitigation actions from the management plan.

In one example, the apparatus further includes means for sending the plurality of peak current detection messages based on a detection of the plurality of peak current events. In one example, the apparatus further includes means for detecting the plurality of peak current events while executing one or more processing tasks using a plurality of processing engines to generate the detection of the plurality of peak current events. In one example, the apparatus further includes means for sending a plurality of trigger signals based on the plurality of mitigation actions; and means for triggering the plurality of mitigation actions based on one or more overcurrent conditions conveyed on the plurality of peak current detection messages. In one example, the plurality of mitigation actions includes an adjustment of a dynamic clock voltage scaling (DCVS) setpoint, a clock frequency reduction, an architectural instruction throttle or a processing engine toggle.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example system peak current management architecture.

FIG. 3 illustrates a first example peak current event detection scheme.

FIG. 4 illustrates a second example peak current event detection scheme.

FIG. 5 illustrates a third example peak current event detection scheme.

FIG. 6 illustrates a fourth example peak current event detection scheme.

FIG. 7 illustrates an example of a mitigation prioritization table.

FIG. 8 illustrates an example of a mitigation duration table.

FIG. 9 illustrates an example of a peak current mitigation scheme.

FIG. 10 illustrates an example flow diagram for implementing peak current mitigation for a plurality of processing engines.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

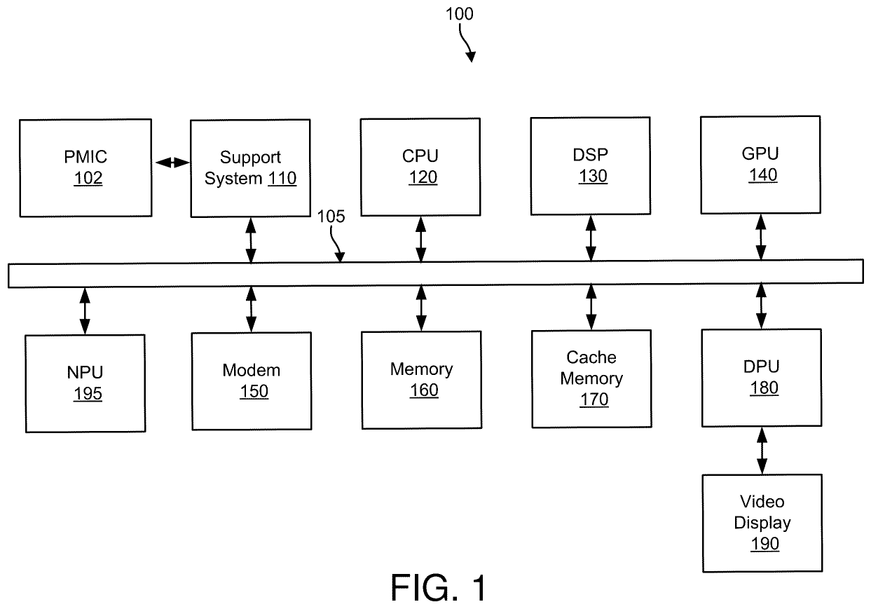

FIG. 1 illustrates an example information processing system 100. In one example, the information processing system 100 includes a plurality of processing engines, or processor cores, such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines.

In one example, the information processing system 100 includes a neural processing unit (NPU) 195. In one example, the NPU 195 is a specialized processing engine for neural network data structures. For example, the NPU 195 is a processing engine used for artificial intelligence (AI) applications.

In one example, the information processing system 100 of FIG. 1 is energized from a power supply with a power management integrated circuit (PMIC) 102. For example, the PMIC 102 may provide voltage regulation, current limiting, battery management, etc. In one example, the PMIC 102 provides a plurality of regulated dc voltage rails to a plurality of processing engines in the information processing system 100.

In one example, each regulated de voltage rail of the plurality of regulated de voltage rails delivers a load current which depends on an instantaneous load power demand for each regulated dc voltage rail. That is, as the instantaneous load power demand increases, the load current increases proportionally, for a fixed regulated de voltage level. In one example, the load current for each regulated de voltage rail is constrained to a predetermined maximum load current threshold. In one example, the information processing system 100 requires a system peak current management scheme to maintain each load current to a level no greater than its predetermined maximum current threshold.

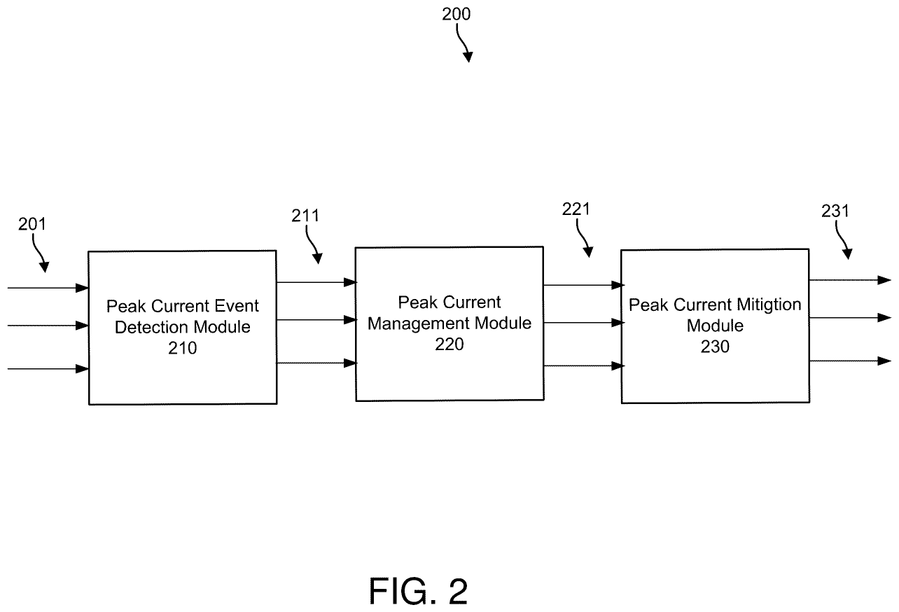

FIG. 2 illustrates an example system peak current management architecture 200. In one example, the system peak current management architecture 200 includes a peak current event detection module 210, a peak current management module 220 and a peak current mitigation module 230. In one example, the peak current event detection module 210 monitors a plurality of load currents 201 for a plurality of loads (e.g., processing engines).

In one example, the peak current event detection module 210 receives the plurality of load currents from a power management integrated circuit (PMIC) or from the plurality of processing engines. In one example, the peak current event detection module 210 sends a plurality of detection signals 211 to the peak current management module 220. In one example, the plurality of detection signals indicate which load current of the plurality of load currents exceeds its predetermined maximum current threshold. In one example, each detection signal of the plurality of detection signals is a binary state signal (i.e., with exactly two states) to indicate an exceedance of the predetermined maximum current threshold.

In one example, the peak current management module 220 determines mitigation actions based on the plurality of detection signals 211. In one example, the peak current management module 220 sends a plurality of trigger signals 221 to the peak current mitigation module 230. In one example, the plurality of trigger signals 221 indicate which mitigation action should be taken on the plurality of load currents. In one example, the peak current mitigation module 230 executes mitigation actions by sending a plurality of mitigation signals 231 to the plurality of processing engines or to the PMIC.

In one example, the system peak current management architecture 200 may be used as a hardware-based solution for avoiding simultaneous peak current events in the information processing system 100. In one example, the peak current event detection module 210 may provide the plurality of detection signals based on the following schemes:
PMIC message-based rail peak current detection
Core digital power meter (DPM)-based rail peak current detection
Current sensor-based rail peak current detection
Static DPM-based rail peak current detection

In one example, the peak current management module 220 coordinates mitigation actions depending on the plurality of detection signals. In one example, the peak current management module 220 may provide the plurality of trigger signals 221 depending on the mitigation actions it determines.

In one example, the peak current mitigation module 230 regulates the plurality of load currents according to the plurality of trigger signals 221 it receives. In one example, the peak current mitigation module 230 sends the plurality of mitigation signals 231 to the plurality of processing engines or to the PMIC.

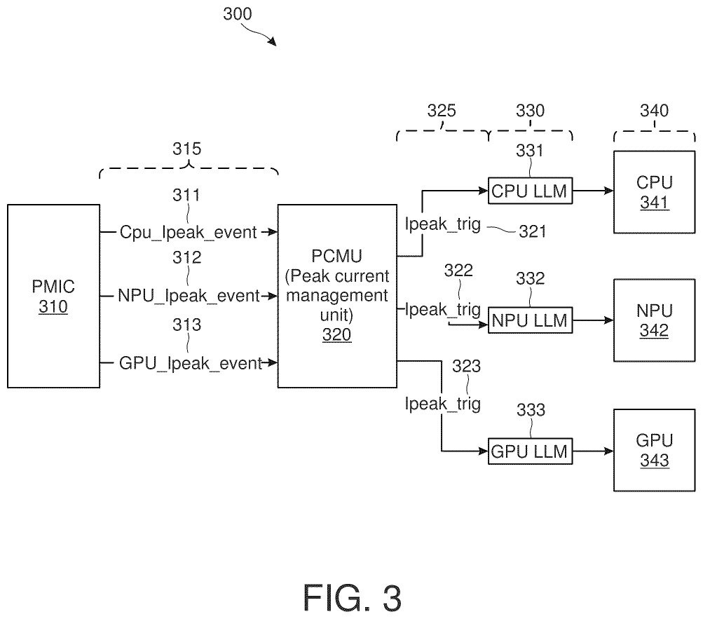

FIG. 3 illustrates a first example peak current event detection scheme 300. In one example, a PMIC 310 provides a plurality of peak current detection messages 315 for a plurality of processing engines to a peak current management unit (PCMU) 320. In one example, the plurality of peak current detection messages 315 includes a central processing unit (CPU) peak current event message 311, a neural processing unit (NPU) peak current event message 312, a graphics processing unit (GPU) peak current event message 313, etc.

In one example, the PMIC 310 monitors current load demand of each voltage rail of the plurality of processing engines and compares each monitored current load with a current threshold. In one example, if a monitored current load exceeds its current threshold, the PMIC 310 sends an alert signal or an alert message (e.g., a system power management interface (SPMI) message) to the PCMU 320 to provide an overcurrent alert message. In one example, the alert signal or alert message is one of the plurality of peak current detection messages 315, for example, the CPU peak current event message 311, the NPU peak current event message 312 or the GPU peak current event message 313. In one example, the PMIC 310 provides one peak current detection message for each voltage rail of the plurality of processing engines.

In one example, the PCMU 320 receives the plurality of peak current detection messages 315 and determines mitigation actions. In one example, the PCMU 320 sends a plurality of trigger signals 325 to a plurality of peak current mitigation units 330 depending on the mitigation actions it determines. In one example, the plurality of trigger signals 325 includes a CPU peak current trigger message 321, a NPU peak current trigger message 322, a GPU peak current trigger message 323, etc.

In one example, the plurality of peak current mitigation units 330 includes a CPU local limit management (LLM) unit 331, a NPU LLM unit 332, a GPU LLM unit 333, etc. In one example, the plurality of peak current mitigation units 330 executes the mitigation actions determined by the PCMU 320.

In one example, the CPU LLM unit 331 mitigates an overcurrent condition in a CPU 341, the NPU LLM unit 332 mitigates an overcurrent condition in a NPU 342, the GPU LLM unit 333 mitigates an overcurrent condition in a GPU 343, etc.

In one example, the CPU 341 is a general purpose processing engine. In one example, the NPU 342 is a specialized artificial intelligence (AI) processing engine optimized for performing neural network data structures and processing (e.g., training and inference). In one example, the GPU 343 is a specialized processing engine optimized for graphical signal processing (e.g., rendering).

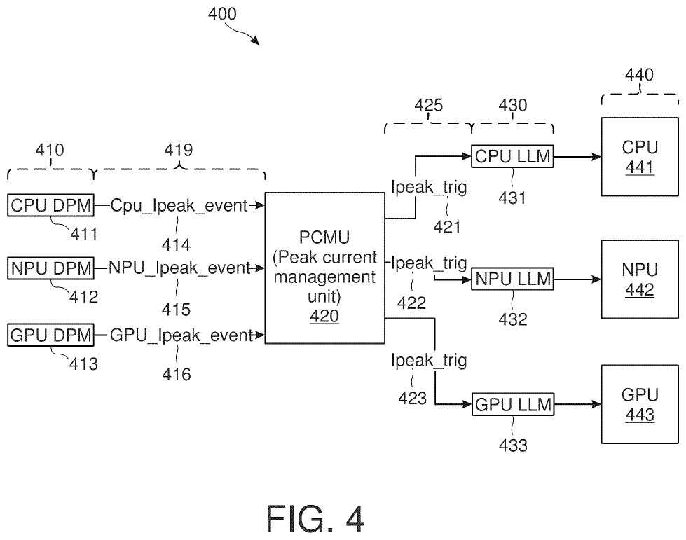

FIG. 4 illustrates a second example peak current event detection scheme 400. In one example, a plurality of digital power meters (DPM) 410 provides a plurality of pcak current detection messages 419 for a plurality of processing engines to a peak current management unit (PCMU) 420. In one example, the plurality of DPMs 410 includes a CPU DPM 411, a NPU DPM 412, a GPU DPM 413, etc. In one example, the plurality of peak current detection messages 419 includes a central processing unit (CPU) peak current event message 414, a neural processing unit (NPU) peak current event message 415, a graphics processing unit (GPU) peak current event message 416, etc.

In one example, the plurality of DPMs 410 monitors current load demand of each voltage rail of the plurality of processing engines and compares each monitored current load with a current threshold. In one example, the plurality of DPMs 410 is internal to the plurality of processing engines and measures current load demand based on a voltage, a clock frequency, a temperature and a workload of a processing engine. In one example, the plurality of DPMs 410 monitors an instruction set of each processing engine of the plurality of processing engines and adjusts the current load demand accordingly. In one example, the plurality of DPMs 410 can detect and report overcurrent conditions by comparing the current load demand with the current threshold. In one example, if a monitored current load exceeds its current threshold, the plurality of DPMs 410 sends an alert signal or an alert message (e.g., a system power management interface, SPMI, message) to the PCMU 420 to provide an overcurrent alert message. In one example, the alert signal or alert message is one of the plurality of peak current detection messages 419, for example, the CPU peak current event message 414, the NPU peak current event message 415 or the GPU peak current event message 416. In one example, the plurality of DPMs 410 provides one peak current detection message for each voltage rail of the plurality of processing engines.

In one example, the PCMU 420 receives the plurality of peak current detection messages 419 and determines mitigation actions. In one example, the PCMU 420 sends a plurality of trigger signals 425 to a plurality of peak current mitigation units 430 depending on the mitigation actions it determines. In one example, the plurality of trigger signals 425 includes a CPU peak current trigger message 421, a NPU peak current trigger message 422, a GPU peak current trigger message 423, etc.

In one example, the plurality of peak current mitigation units 430 includes a CPU local limit management (LLM) unit 431, a NPU LLM unit 432, a GPU LLM unit 433, etc. In one example, the plurality of peak current mitigation units 430 executes the mitigation actions determined by the PCMU 420.

In one example, the CPU LLM unit 431 mitigates an overcurrent condition in a CPU 441, the NPU LLM unit 432 mitigates an overcurrent condition in a NPU 442, the GPU LLM unit 433 mitigates an overcurrent condition in a GPU 443, etc.

In one example, the CPU 441 is a general purpose processing engine. In one example, the NPU 442 is a specialized artificial intelligence (AI) processing engine optimized for performing neural network data structures and processing (e.g., training and inference). In one example, the GPU 443 is a specialized processing engine optimized for graphical signal processing (e.g., rendering).

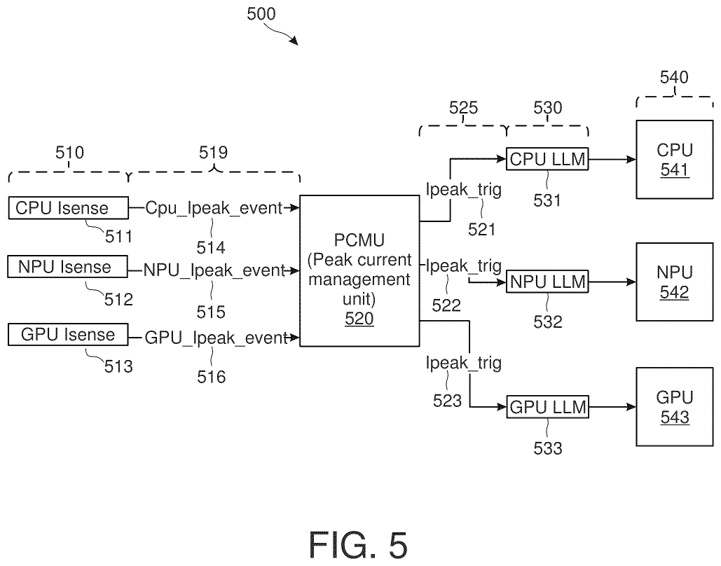

FIG. 5 illustrates a third example peak current event detection scheme 500. In one example, a plurality of current sensors 510 provides a plurality of peak current detection messages 519 for a plurality of processing engines to a peak current management unit (PCMU) 520. In one example, the plurality of current sensors 510 includes a CPU current sensor 511, a NPU current sensor 512, a GPU current sensor 513, etc. In one example, the plurality of peak current detection messages 519 includes a central processing unit (CPU) peak current event message 514, a neural processing unit (NPU) peak current event message 515, a graphics processing unit (GPU) peak current event message 516, etc.

In one example, the plurality of current sensors 510 monitors current load demand of each voltage rail of the plurality of processing engines and compares each monitored current load of the plurality of processing engines with a current threshold. In one example, the plurality of current sensors 510 is internal to the plurality of processing engines and is a plurality of analog sensors which measures current load demand in real time. In one example, the plurality of current sensors 510 can detect and report overcurrent conditions by comparing the current load demand with the current threshold. In one example, if a monitored current load exceeds its current threshold, the plurality of current sensors 510 sends an alert signal or an alert message (e.g., a system power management interface, SPMI, message) to the PCMU 520 to provide an overcurrent alert message. In one example, the alert signal or alert message is one of the plurality of peak current detection messages 519, for example, the CPU peak current event message 514, the NPU peak current event message 515 or the GPU peak current event message 516. In one example, the plurality of current sensors 510 provides one peak current detection message for each voltage rail of the plurality of processing engines.

In one example, the PCMU 520 receives the plurality of peak current detection messages 519 and determines mitigation actions. In one example, the PCMU 520 sends a plurality of trigger signals 525 to a plurality of peak current mitigation units 530 depending on the mitigation actions it determines. In one example, the plurality of trigger signals 525 includes a CPU peak current trigger message 521, a NPU peak current trigger message 522, a GPU peak current trigger message 523, etc.

In one example, the plurality of peak current mitigation units 530 includes a CPU local limit management (LLM) unit 531, a NPU LLM unit 532, a GPU LLM unit 533, etc. In one example, the plurality of peak current mitigation units 530 executes the mitigation actions determined by the PCMU 520.

In one example, the CPU LLM unit 531 mitigates an overcurrent condition in a CPU 541, the NPU LLM unit 532 mitigates an overcurrent condition in a NPU 542, the GPU LLM unit 533 mitigates an overcurrent condition in a GPU 543, etc.

In one example, the CPU 541 is a general purpose processing engine. In one example, the NPU 542 is a specialized artificial intelligence (AI) processing engine optimized for performing neural network data structures and processing (e.g., training and inference). In one example, the GPU 543 is a specialized processing engine optimized for graphical signal processing (e.g., rendering).

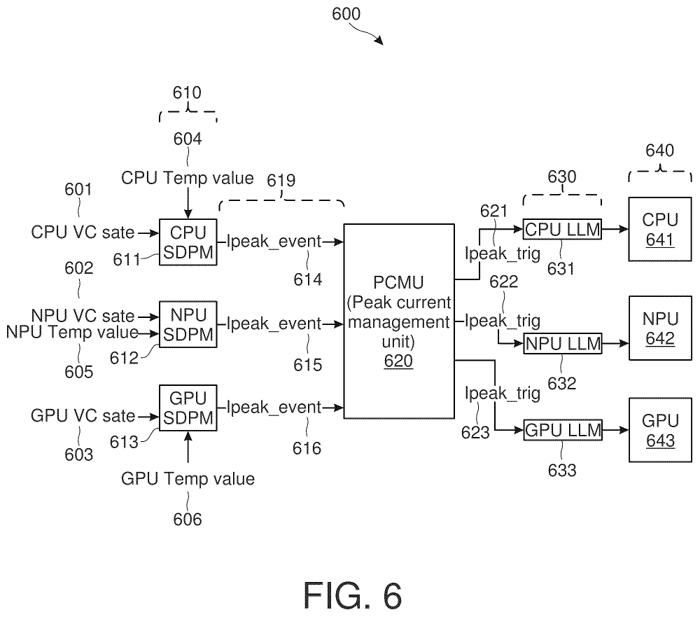

FIG. 6 illustrates a fourth example peak current event detection scheme 600. In one example, a plurality of static digital power meters (SDPM) 610 provides a plurality of peak current detection messages 619 for a plurality of processing engines to a peak current management unit (PCMU) 620. In one example, the plurality of SDPMs 610 includes a CPU SDPM 611, a NPU SDPM 612, a GPU SDPM 613, etc. In one example, the plurality of peak current detection messages 619 includes a central processing unit (CPU) peak current event message 614, a neural processing unit (NPU) peak current event message 615, a graphics processing unit (GPU) peak current event message 616, etc.

In one example, the plurality of SDPMs 610 estimates current load demand of each voltage rail of the plurality of processing engines using a plurality of voltages, a plurality of clock frequencies and a plurality of temperatures. In one example, the plurality of voltages includes a voltage measurement for each voltage rail of the plurality of processing engines. In one example, the plurality of clock frequencies includes a clock frequency measurement for each clock of the plurality of processing engines. In one example, the plurality of temperatures includes a temperature measurement for each processing engine of the plurality of processing engines.

In one example, the estimated current load demand may be computed as a weighted superposition of the voltage measurement, the clock frequency measurement and the temperature measurement using a plurality of weights. In one example, the estimated current load demand Iₑₛₜ may be computed as:

$${I}_{est} = {w}_{1} v + {w}_{2} f + {w}_{3} T ,$$

where
v=voltage measurement with a first weight w₁
f=clock frequency measurement with a second weight w₂
T=temperature measurement with a third weight w₃.

In one example, the plurality of weights includes the first weight w₁, the second weight w₃ and the third weight w₃. In one example, the plurality of weights may be chosen for dimensional consistency (i.e., converting voltage units (e.g. V) to current units (e.g., A), converting frequency units (e.g., MHz) to current units and converting temperature units (e.g., deg C.) to current units, etc.). In one example, the plurality of weights may be chosen to emphasize or de-emphasize constituents of the weighted superposition (i.e., voltage measurement, clock frequency measurement, temperature measurement, etc.).

In one example, the plurality of SDPMs compares each estimated current load demand with a current threshold. In one example, the plurality of SDPMs 610 is internal to the plurality of processing engines. In one example, the plurality of SDPMs 610 can detect and report overcurrent conditions by comparing the estimated current load demand with the current threshold. In one example, if an estimated current load exceeds its current threshold, the plurality of SDPMs 610 sends an alert signal or an alert message (e.g., a system power management interface, SPMI, message) to the PCMU 620 to provide an overcurrent alert message. In one example, the alert signal or alert message is one of the plurality of peak current detection messages 619, for example, the CPU peak current event message 614, the NPU peak current event message 615 or the GPU peak current event message 616. In one example, the plurality of SDPMs 610 provides one peak current detection message for each voltage rail of the plurality of processing engines.

In one example, the PCMU 620 receives the plurality of peak current detection messages 619 and determines a plurality of mitigation actions. In one example, the PCMU 620 sends a plurality of trigger signals 625 to a plurality of peak current mitigation units 630 depending on the plurality of mitigation actions it determines. In one example, the plurality of trigger signals 625 includes a CPU peak current trigger message 621, a NPU peak current trigger message 622, a GPU peak current trigger message 623, etc.

In one example, the plurality of peak current mitigation units 630 includes a CPU local limit management (LLM) unit 631, a NPU LLM unit 632, a GPU LLM unit 633, etc. In one example, the plurality of peak current mitigation units 630 executes the mitigation actions determined by the PCMU 620.

In one example, the CPU LLM unit 631 mitigates an overcurrent condition in a CPU 641, the NPU LLM unit 632 mitigates an overcurrent condition in a NPU 642, the GPU LLM unit 633 mitigates an overcurrent condition in a GPU 643, etc.

In one example, the CPU 641 is a general purpose processing engine. In one example, the NPU 642 is a specialized artificial intelligence (AI) processing engine optimized for performing neural network data structures and processing (e.g., training and inference). In one example, the GPU 643 is a specialized processing engine optimized for graphical signal processing (e.g., rendering).

In one example, a peak current management unit (PCMU) receives a plurality of peak current detection messages from a peak current event detection module and determines the plurality of mitigation actions. In one example, the PCMU sends a plurality of trigger signals to a plurality of peak current mitigation units depending on the plurality of mitigation actions it determines. In one example, the PCMU triggers the plurality of mitigation actions based on overcurrent conditions conveyed on the plurality of peak current detection messages.

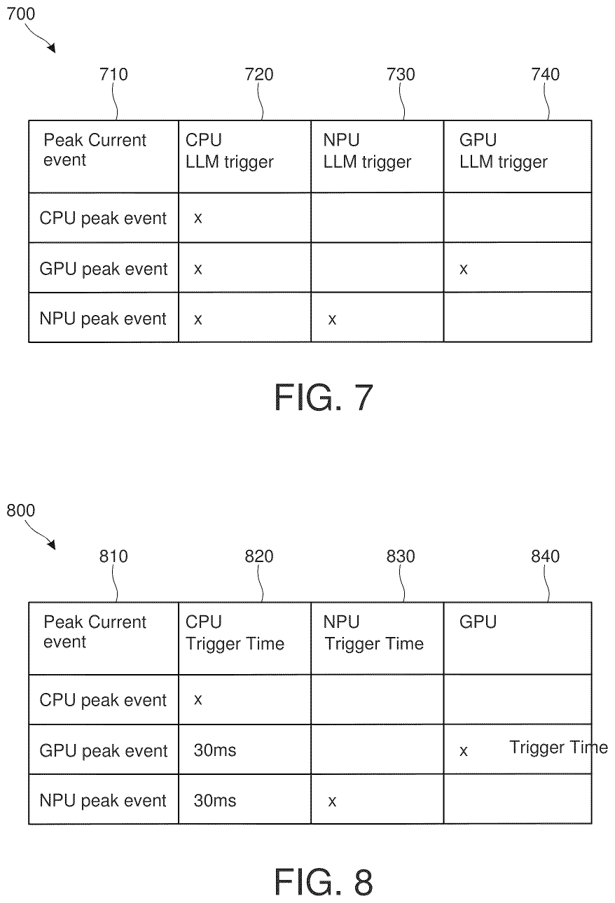

In one example, the PCMU includes a PCMU memory which stores a plurality of configuration tables used to determine the plurality of mitigation actions. FIG. 7 illustrates an example of a mitigation prioritization table 700. In one example, the plurality of configuration tables includes the mitigation prioritization table 700 illustrated in FIG. 7.

In one example, the mitigation prioritization table 700 indicates a priority for each peak current event. In one example, a first column 710 of the mitigation prioritization table 700 enumerates a plurality of peak current events (e.g., CPU peak current event, GPU peak current event, NPU peak current event, etc.). In one example, a second column 720 of the mitigation prioritization table 700 indicates whether or not a CPU receives a trigger signal based on the plurality of peak current events. In one example, a third column 730 of the mitigation prioritization table 700 indicates whether or not a NPU receives a trigger signal based on the plurality of peak current events. In one example, a fourth column 740 of the mitigation prioritization table 700 indicates whether or not a GPU receives a trigger signal based on the plurality of peak current events.

For example, based on the mitigation prioritization table 700, the CPU receives a trigger signal with a presence of a CPU peak current event, a GPU peak current event, or a NPU peak current event. For example, based on the mitigation prioritization table 700, the NPU receives a trigger signal only with a presence of a NPU peak current event. For example, based on the mitigation prioritization table 700, the GPU receives a trigger signal only with a presence of a GPU peak current event.

In one example, simultaneous mitigation actions for two or more processing engines avoids simultaneous peak current events by implementation of the prioritization specified in the mitigation prioritization table 700. For example, with the presence of a NPU peak current event, both the CPU and NPU receive a trigger signal to implement the plurality of mitigation actions.

In one example, the PCMU also determines a time duration of each mitigation action of the plurality of mitigation actions. In one example, one mitigation action is a throttle. In one example, the throttle is a reduction in clock frequency. In one example, the throttle is a reduction in rail voltage. In one example, the throttle is an adjustment in operational parameters which reduces dc power consumption of a processing engine.

FIG. 8 illustrates an example of a mitigation duration table 800. In one example, the plurality of configuration tables includes the mitigation duration table 800 illustrated in FIG. 8. In one example, the mitigation duration table 800 includes a mitigation time duration for each peak current event. In one example, a first column 810 of the mitigation duration table 800 enumerates a plurality of peak current events (e.g., CPU peak current event, GPU peak current event, NPU peak current event, etc.). In one example, a second column 820 of the mitigation duration table 800 indicates a mitigation time duration for the CPU based on the plurality of peak current events. In one example, a third column 830 of the mitigation duration table 800 indicates a mitigation time duration for the NPU based on the plurality of peak current events. In one example, a fourth column 840 of the mitigation duration table 800 indicates a mitigation time duration for the GPU based on the plurality of peak current events.

For example, based on the mitigation duration table 800, the CPU has a mitigation time duration equal to a time duration of a CPU peak current event, and equal to 30 ms for a GPU peak current event or a NPU peak current event. For example, based on the mitigation duration table 800, the NPU has a mitigation time duration equal to a time duration of a NPU peak current event. For example, based on the mitigation duration table 800, the GPU has a mitigation time duration equal to a time duration of a GPU peak current event.

In one example, the mitigation duration table 800 may be dynamically reconfigured by software in the plurality of processing engines. For example, the dynamic reconfiguration of the mitigation duration table 800 may be based on a throttle policy strategy set by a key performance indicator (KPI). For example, the KPI may be a workload KPI. For example, the workload KPI may be a thread execution time, a process execution time, etc. For example, the workload KPI may be a software performance metric such as a Whetstone benchmark, a Dhrystone benchmark, etc. For example, the Whetstone benchmark may be used as a KPI for floating point operations. For example, the Dhrystone benchmark may be used as a KPI for fixed point operations.

In one example, a plurality of peak current mitigation units receives a plurality of trigger signals from the PCMU to direct a plurality of mitigation actions. In one example, the plurality of peak current mitigation units includes a plurality of local limit management (LLM) units. In one example, the plurality of LLM units receives the plurality of trigger signals from the PCMU to direct the plurality of mitigation actions.

In one example, the plurality of peak current mitigation units implements one of a plurality of mitigation actions. In one example, a first mitigation action of the plurality of mitigation actions is an adjustment of a dynamic clock voltage scaling (DCVS) setpoint. In one example, the DCVS setpoint specifies an operation setting for a clock frequency and a rail voltage. In one example, the adjustment of the DCVS setpoint results a nominal DCVS setpoint to prevent a current limit event. In one example, the DCVS setpoint is adjusted by software in the plurality of processing engines.

In one example, a second mitigation action of the plurality of mitigation actions is a clock frequency reduction or an architectural instruction throttle. In one example, the clock frequency reduction limits a load current demand. In one example, the architectural instruction throttle reduces a quantity of instructions being executed per unit time.

In one example, a third mitigation action of the plurality of mitigation actions is a processing engine toggle. In one example, the processing engine toggle is a switch from a first operational state to a second operational state. In one example, the first operational state is a higher performance, higher dc power consumption state. In one example, the second operational state is a lower performance, lower dc power consumption state.

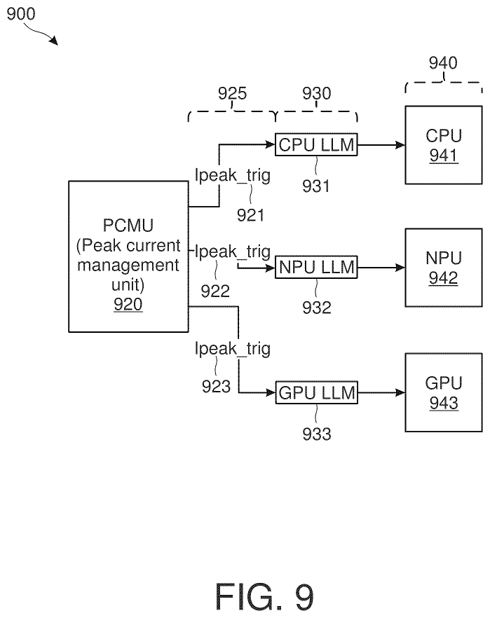

FIG. 9 illustrates an example of a peak current mitigation scheme 900. In one example, the peak current mitigation scheme 900 includes a PCMU 910 which sends a plurality of trigger signals 925 to a plurality of to a plurality of peak current mitigation units 930 depending on mitigation actions it determines. In one example, the plurality of trigger signals 925 includes a CPU peak current trigger message 921, a NPU peak current trigger message 922, a GPU peak current trigger message 923, etc.

In one example, the plurality of peak current mitigation units 930 includes a CPU local limit management (LLM) unit 931, a NPU LLM unit 932, a GPU LLM unit 933, etc. In one example, the plurality of peak current mitigation units 930 executes the mitigation actions determined by the PCMU 920.

In one example, the CPU LLM unit 931 mitigates an overcurrent condition in a CPU 941, the NPU LLM unit 932 mitigates an overcurrent condition in a NPU 942, the GPU LLM unit 933 mitigates an overcurrent condition in a GPU 943, etc.

In one example, the CPU 941 is a general purpose processing engine. In one example, the NPU 942 is a specialized artificial intelligence (AI) processing engine optimized for performing neural network data structures and processing (e.g., training and inference). In one example, the GPU 943 is a specialized processing engine optimized for graphical signal processing (e.g., rendering).

In one example, the plurality of peak current mitigation units 930 implements one of a plurality of mitigation actions. In one example, a first mitigation action of the plurality of mitigation actions is an adjustment of a dynamic clock voltage scaling (DCVS) setpoint. In one example, a second mitigation action of the plurality of mitigation actions is a clock frequency reduction or an architectural instruction throttle. In one example, a third mitigation action of the plurality of mitigation actions is a processing engine toggle.

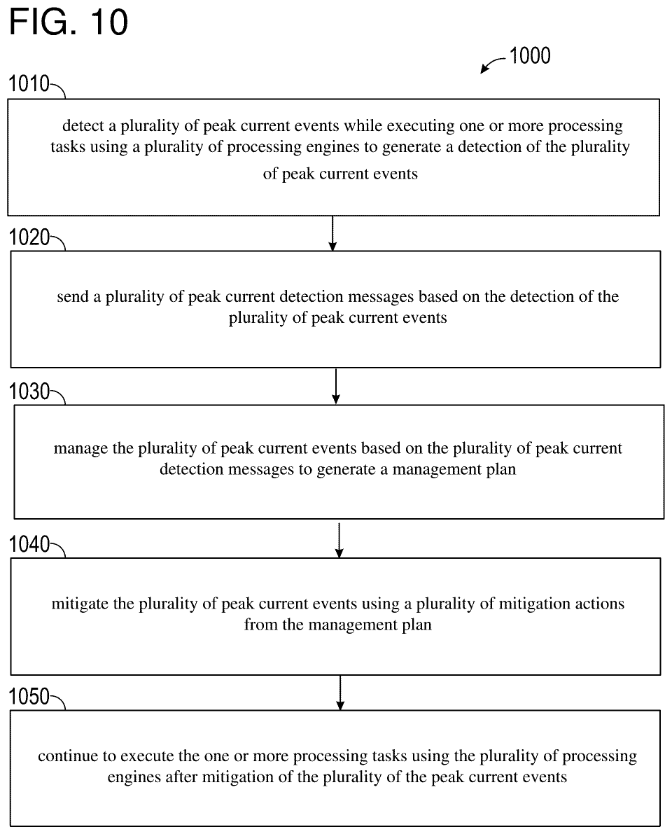

FIG. 10 illustrates an example flow diagram 1000 for implementing peak current mitigation for a plurality of processing engines. In block 1010, detect a plurality of peak current events while executing one or more processing tasks using a plurality of processing engines to generate a detection. In one example, a plurality of peak current events is detected while executing one or more processing tasks using a plurality of processing engines (e.g., a central processing unit (CPU), a neural processing unit (NPU), a graphics processing unit (GPU), etc.) to generate a detection.

In one example, the detection is the detection of the plurality of peak current events. In one example, detect using a plurality of digital power meters (DPMs). In one example, the plurality of DPMs includes one or more of the following: a central processing unit (CPU) DPM, a neural processing unit (NPU) DPM, a graphics processing unit (GPU) DPM, etc.

In one example, detect using a plurality of analog current sensors. In one example, the plurality of analog current sensors includes one or more of the following: a central processing unit (CPU) current sensor, a neural processing unit (NPU) current sensor, a graphics processing unit (GPU) current sensor, etc.

In one example, detect using a plurality of static digital power meters (SDPMs). In one example, the plurality of static digital power meters (SDPMs) includes one or more of the following: a central processing unit (CPU) SDPM, a neural processing unit (NPU) SDPM, a graphics processing unit (GPU) SDPM, etc.

In one example, the detection is performed by a peak current event detection module. In one example, the peak current event detection module monitors a plurality of load currents for a plurality of loads (e.g., processing engines). In one example, the detection monitors current load demand of each voltage rail of the plurality of processing engines and compares each monitored current load with a current threshold. In one example, the step of block 1010 is performed by a power management integrated circuit (PMIC).

In block 1020, send a plurality of peak current detection messages based on the detection of the plurality of peak current events. In one example, a plurality of peak current detection messages is sent based on the detection of the plurality of peak current events. In one example, the plurality of peak current detection messages includes a central processing unit (CPU) peak current event message, a neural processing unit (NPU) peak current event message, or a graphics processing unit (GPU) peak current event message. In one example, if a monitored current load exceeds its current threshold, each peak current detection message is an alert signal or an alert message (e.g., a system power management interface, SPMI, message) to provide an overcurrent alert message.

In one example, the step of block 1020 is performed by one or more of the following: a power management integrated circuit (PMIC), a neural processing unit (NPU) current sensor, a graphics processing unit (GPU) current sensor, a central processing unit (CPU) static digital power meters (SDPM), a neural processing unit (NPU) static digital power meters (SDPM), a graphics processing unit (GPU) static digital power meters (SDPM), a central processing unit (CPU) digital power meter (DPM), a neural processing unit (NPU) digital power meter (DPM), a graphics processing unit (GPU) digital power meter (DPM).

In block 1030, manage the plurality of peak current events based on the plurality of peak current detection messages to generate a management plan. In one example, the plurality of peak current events is managed based on the plurality of peak current detection messages to generate a management plan. In one example, the management plan includes a plurality of mitigation actions. In one example, the management plan sends a plurality of trigger signals depending on the plurality of mitigation actions it determines. In one example, the management plan triggers the plurality of mitigation actions based on overcurrent conditions conveyed on the plurality of peak current detection messages.

In one example, the management plan includes a plurality of configuration tables used to determine the plurality of mitigation actions. In one example, the plurality of configuration tables includes a mitigation prioritization table. In one example, the plurality of configuration tables includes a mitigation duration table. In one example, the mitigation prioritization table indicates a priority for each peak current event. In one example, the mitigation duration table includes a mitigation time duration for each peak current event. In one example, the step of block 1030 is performed by a peak current management unit (PCMU).

In block 1040, mitigate the plurality of peak current events using a plurality of mitigation actions from the management plan. In one example, the plurality of peak current events is mitigated using a plurality of mitigation actions from the management plan. In one example, the management plan determines mitigation of the plurality of peak current events. In one example, a first mitigation action of the plurality of mitigation actions is an adjustment of a dynamic clock voltage scaling (DCVS) setpoint. In one example, a second mitigation action of the plurality of mitigation actions is a clock frequency reduction or an architectural instruction throttle. In one example, a third mitigation action of the plurality of mitigation actions is a processing engine toggle. In one example, the step of block 1040 is performed by one or more of a plurality of peak current mitigation units which may include one or more of the following: a central processing unit (CPU) local limit management (LLM) unit, a neural processing unit (NPU) local limit management (LLM) unit, a graphics processing unit (GPU) local limit management (LLM) unit, etc.

In block 1050, continue to execute the one or more processing tasks using the plurality of processing engines after mitigation of the plurality of the peak current events. In one example, the one or more processing tasks continues executing using the plurality of processing engines after mitigation of the plurality of the peak current events. In one example, the step of block 1050 is performed by a central processing unit (CPU), a graphics processing unit (GPU), a neural processing unit (NPU), etc.

In one example, the mitigation results a nominal DCVS setpoint to prevent a current limit event. In one example, the mitigation limits a load current demand. In one example, the mitigation reduces a quantity of instructions being executed per unit time. In one example, the mitigation is a switch from a first operational state with higher performance and higher dc power consumption. In one example, the mitigation is a switch to a second operational state with lower performance and lower de power consumption.

In one aspect, one or more of the steps for providing peak current mitigation in FIG. 10 may be executed by one or more processors which may include hardware, software, firmware, etc. The one or more processors, for example, may be used to execute software or firmware needed to perform the steps in the flow diagram of FIG. 10. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure

What is claimed is:

1. An apparatus comprising
a processing engine configured to perform general purpose processing; and
a power management integrated circuit (PMIC) coupled to the processing engine, the PMIC configured to manage a plurality of peak current events associated with the processing engine based on a plurality of peak current detection messages to generate a management plan, and configured to mitigate the plurality of peak current events using a plurality of mitigation actions from the management plan.

2. The apparatus of claim 1, wherein the PMIC is further configured to send the plurality of peak current detection messages based on a detection of the plurality of peak current events.

3. The apparatus of claim 1, wherein the processing engine is further configured to send the plurality of peak current detection messages based on a detection of the plurality of peak current events.

4. The apparatus of claim 2, further comprising a digital power meter (DPM) residing within the processing engine, the digital power meter configured to measure a current load demand based on a voltage, a clock frequency, a temperature and a workload of the processing engine.

5. The apparatus of claim 3, further comprising a digital power meter (DPM) residing within the processing engine, the digital power meter configured to measure a current load demand based on a voltage, a clock frequency, a temperature and a workload of the processing engine.

6. The apparatus of claim 2, further comprising a current sensor residing within the processing engine, the current sensor configured to compare a monitored current load of the processing engine with a current threshold.

7. The apparatus of claim 3, further comprising a current sensor residing within the processing engine, the current sensor configured to compare a monitored current load of the processing engine with a current threshold.

8. A method comprising:
managing a plurality of peak current events based on a plurality of peak current detection messages to generate a management plan; and
mitigating the plurality of peak current events using a plurality of mitigation actions from the management plan.

9. The method of claim 8, further comprising sending a plurality of trigger signals based on the plurality of mitigation actions.

10. The method of claim 9, further comprising triggering the plurality of mitigation actions based on one or more overcurrent conditions conveyed on the plurality of peak current detection messages.

11. The method of claim 8, wherein the management plan includes a plurality of configuration tables used to determine the plurality of mitigation actions.

12. The method of claim 11, wherein the plurality of configuration tables includes a mitigation prioritization table or a mitigation duration table.

13. The method of claim 8, wherein the plurality of mitigation actions includes an adjustment of a dynamic clock voltage scaling (DCVS) setpoint, a clock frequency reduction, an architectural instruction throttle or a processing engine toggle.

14. The method of claim 8, further comprising sending the plurality of peak current detection messages based on a detection of the plurality of peak current events.

15. The method of claim 14, further comprising detecting the plurality of peak current events while executing one or more processing tasks using a plurality of processing engines to generate the detection of the plurality of peak current events.

16. An apparatus for peak current mitigation comprising:
means for managing a plurality of peak current events based on a plurality of peak current detection messages to generate a management plan; and
means for mitigating the plurality of peak current events using a plurality of mitigation actions from the management plan.

17. The apparatus of claim 16, further comprising means for sending the plurality of peak current detection messages based on a detection of the plurality of peak current events.

18. The apparatus of claim 17, further comprising means for detecting the plurality of peak current events while executing one or more processing tasks using a plurality of processing engines to generate the detection of the plurality of peak current events.

19. The apparatus of claim 18, further comprising:
means for sending a plurality of trigger signals based on the plurality of mitigation actions; and
means for triggering the plurality of mitigation actions based on one or more overcurrent conditions conveyed on the plurality of peak current detection messages.

20. The apparatus of claim 19, wherein the plurality of mitigation actions includes an adjustment of a dynamic clock voltage scaling (DCVS) setpoint, a clock frequency reduction, an architectural instruction throttle or a processing engine toggle.
